(19) United States
(12) Patent Application Publication
(10) Pub. No.: US 2026/0304261 A1
(43) Pub. Date: Oct. 1, 2026

(54) METHODS AND COMMUNICATIONS DEVICES

(71) Applicant: Sony Group Corporation, Tokyo (JP)

(72) Inventors: Vivek SHARMA, Basingstoke (GB); Yuxin WEI, Basingstoke (GB); Yassin Aden AWAD, Basingstoke (GB); Hideji WAKABAYASHI, Basingstoke (GB); Samuel Asangbeng ATUNGSIRI, Basingstoke (GB)

(73) Assignee: Sony Group Corporation, Tokyo (JP)

(21) Appl. No.: 18/880,564

(22) PCT Filed: Jun. 27, 2023
(86) PCT No.: PCT/EP2023/067434

§ 371 Date: Jan. 2, 2025

(30) Foreign Application Priority Data
Jul. 13, 2022 (EP) 22184824.5

(51) Int. Cl. H04W 36/08; H04B 17/309; H04B 17/318; H04W 36/00; H04W 76/20

(52) U.S. Cl. CPC H04W 36/08; H04B 17/328; H04B 17/346; H04W 36/0058; H04W 76/20

(57) ABSTRACT

Embodiments provide methods and apparatus for operating communication devices within wireless networks. The method involves transmitting and receiving signals with a first infrastructure equipment and, upon meeting certain conditions, initiating a handover to a second infrastructure equipment. This involves sending a measurement report to the network, receiving radio resource control parameters from the first infrastructure equipment, and implementing these parameters based on a sustainability profile. Finally, the communication device signals the handover's completion to the second infrastructure equipment.

### BACKGROUND

### Field of Disclosure

The present disclosure relates to communications devices, infrastructure equipment and methods for the more efficient and sustainable operation of a communications device in a wireless communications network.

The present application claims the Paris Convention priority from European patent application number EP 22184824.5, filed on 13 Jul. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is extended Reality (XR), which may be provided by various user equipment such as wearable devices. XR combines real-world and virtual environments, incorporating aspects such as augmented reality (AR), mixed reality (MR), and virtual reality (VR), and thus requires high quality and minimised interaction delay. Services such as URLLC and XR therefore represent a challenging example for both LTE type communications systems and 5G/NR communications systems, as well as future generation communications systems.

New and future services and wireless communications systems are also becoming increasingly focussed on meeting or contributing to sustainability considerations. The increasing use of different types of network infrastructure equipment and terminal devices associated with different traffic profiles, particularly in view of such sustainability considerations, give rise to new challenges for efficiently and sustainably handling communications in wireless communications systems that need to be addressed.

### SUMMARY OF THE DISCLOSURE

The present disclosure can help address or mitigate at least some of the issues discussed above.

Embodiments of the present technique can provide methods, apparatus and circuitry for operating communications devices and infrastructure equipment. In particular, the present technique relates to a method of operating a communications device configured to transmit signals to and/or receive signals from a wireless communications network via a wireless access interface provided by the wireless communications network, the wireless communications network comprising at least a first and a second infrastructure equipment. The method comprises transmitting signals to and/or receiving signals from the first infrastructure equipment, responsive to a condition being satisfied, triggering a handover procedure from the first infrastructure equipment to the second infrastructure equipment by transmitting a measurement report to the wireless communications network, and receiving, from the first infrastructure equipment, an indication of radio resource control parameters to be implemented by the communications device for communication with the second infrastructure equipment. The radio resource control parameters to be implemented are related to a sustainability profile. Finally, the method comprises transmitting, to the second infrastructure equipment, an indication of the completion of the handover procedure.

Other embodiments of the present technique relate to a method of operating an infrastructure equipment forming part of a wireless communications network comprising at least a first and a second infrastructure equipment, the infrastructure equipment being configured to transmit signals to and/or receive signals from a communications device via a wireless access interface provided by the wireless communications network. The method comprises transmitting signals to and/or receiving signals from the communications device, receiving, from the communications device, a measurement report, the reception of the measurement report triggering a handover procedure from the first infrastructure equipment to the second infrastructure equipment, and transmitting, to the communications device, an indication of radio resource control parameters to be implemented by the communications device for communication with the second infrastructure equipment. Here, as above, the radio resource control parameters to be implemented are related to a sustainability profile.

Further embodiments of the present technique relate to a method of operating a communications device configured to transmit signals to and/or receive signals from a wireless communications network via a wireless access interface provided by the wireless communications network. The method comprises transmitting signals to and/or receiving signals from the wireless communications network, and determining that a sustainability profile related to the communications device is to be created. This sustainability profile is determined by the communications device based on at least one parameter including transmission power and number of retransmissions employed by the communications device. Alternatively to the above determining step, the method comprises determining that a sustainability profile related to the communications device is to be updated, wherein again the sustainability profile is determined by the communications device based on at least one parameter including transmission power and number of retransmissions employed by the communications device. In either case, the method concludes by transmitting to the wireless communications network an indication of the determined sustainability profile.

Embodiments of the present technique, which, in addition to methods of operating communications devices, relate to communications devices, circuitry for communications devices, computer programs, and computer-readable storage mediums, can allow for more sustainable and efficient use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically represents aspects of a conventional handover procedure;

FIG. 5 shows a message flow diagram representation of a wireless communications system comprising a communications device and a plurality of infrastructure equipment, in accordance with embodiments of the present technique,

FIG. 6 shows a message flow diagram representation of a wireless communications system comprising a communications device and a plurality of infrastructure equipment, in accordance with embodiments of the present technique,

FIG. 7 shows a flow diagram with respect to a communications device operating in accordance with an embodiment of the present technique,

FIG. 8 shows a representation of a message flow diagram between a communications device and an infrastructure equipment related to a sustainability profile creation and/or update process in accordance with an embodiment of the present technique,

FIG. 9 shows a representation of a message flow diagram between a communications device and an infrastructure equipment related to a bit rate recommendation, that may be adapted in accordance with embodiments of the present technique, and

FIG. 10 shows a representation of a message flow diagram between a communications device and an infrastructure equipment related to a bit rate recommendation, which may be adapted in accordance with embodiments of the present technique.

### DETAILED DESCRIPTION OF THE EMBODIMENTS

### Long Term Evolution Advanced Radio Access Technology (4G)

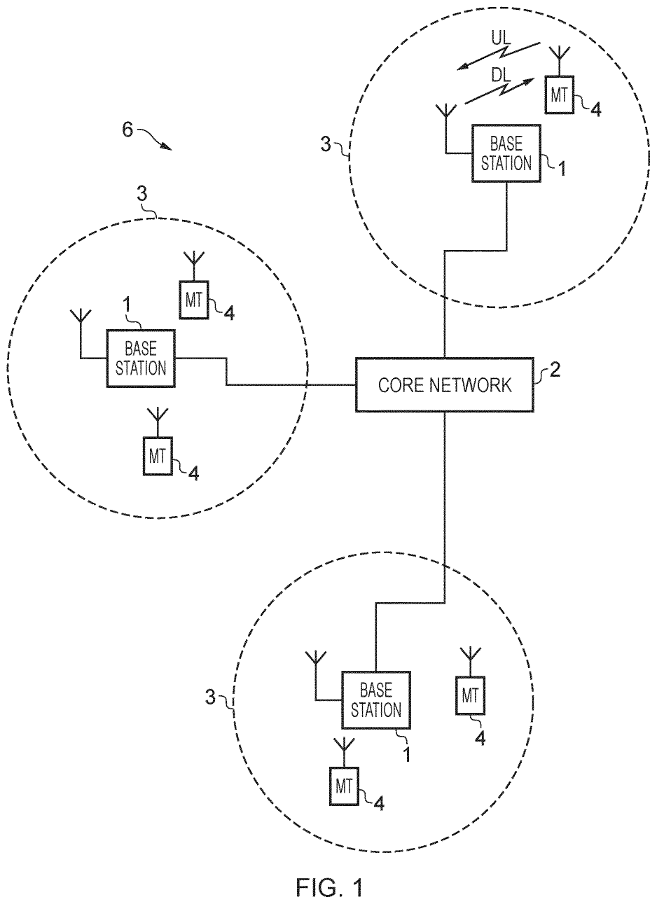

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999 %) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

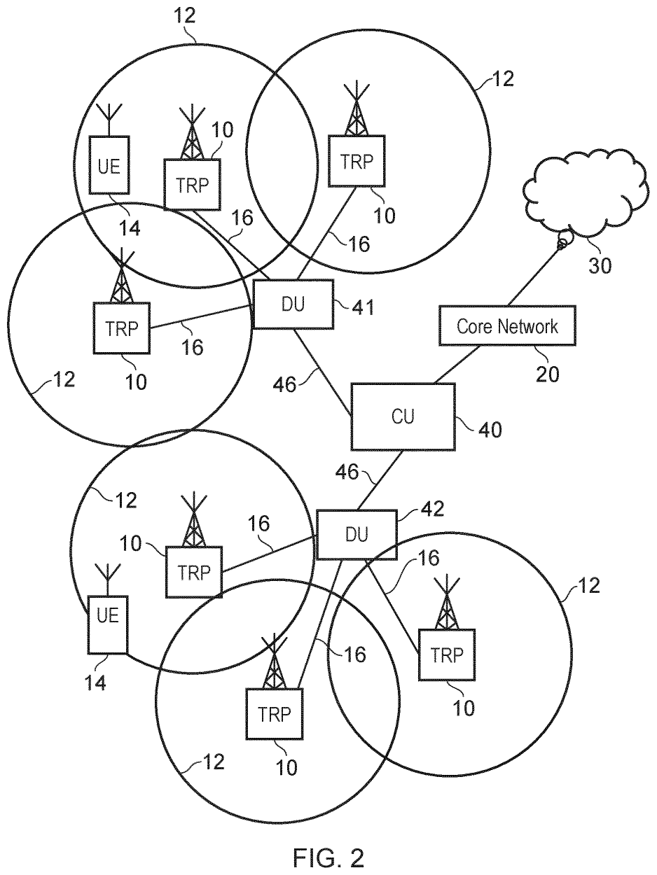

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

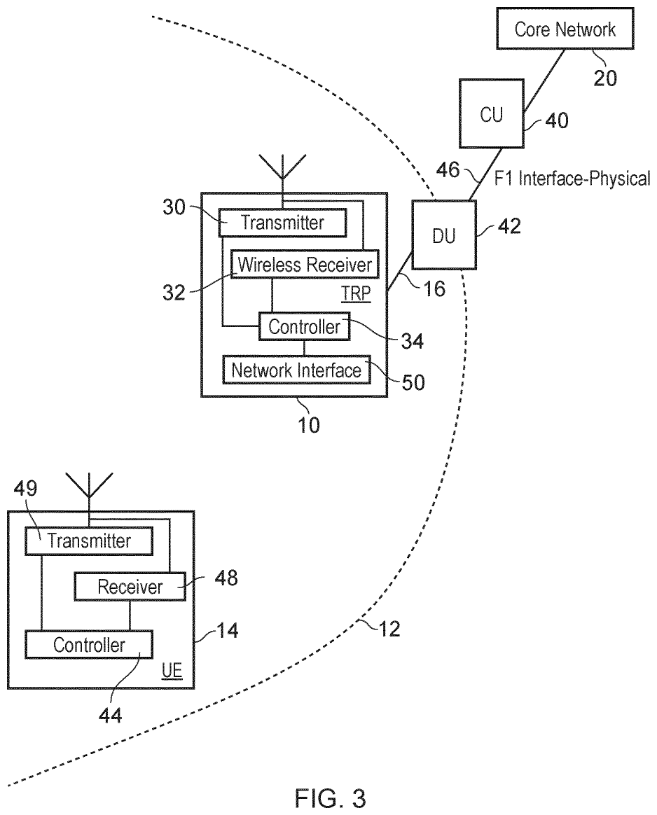

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

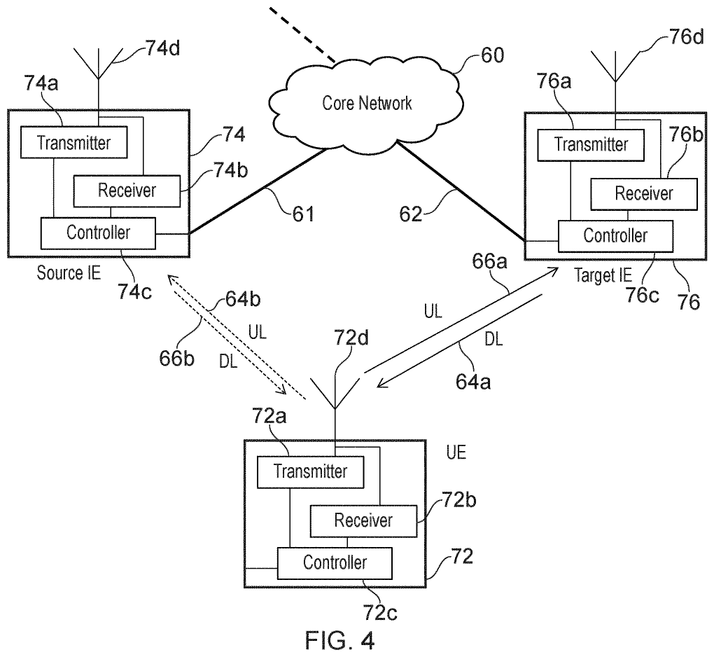

A detailed illustration of a wireless communications network in which a handover (HO) may be performed is shown in FIG. 4. As will be appreciated from FIG. 4, a communications device 72 is handed over from a source infrastructure equipment 74 to a target infrastructure equipment 76 forming part of a radio access network to a core network 60. As will be appreciated the communications device 72 is an example of a communications device such as the communications device 14 of FIGS. 1, 2 and 3. The communications device 72 may be a UE in one example.

Before the handover, the communications device 72 transmits signals on an uplink UL and receive signals on a downlink DL from a source infrastructure equipment 74. The source infrastructure equipment 74 and the target infrastructure equipment 76 may each be thought of as a gNB 1 as shown in FIG. 1 or a combination of a controlling node 40 and TRP 10 as shown in FIGS. 2 and 3. Before the handover, the communications device 72 is shown to transmit uplink data to the source infrastructure equipment 74 via uplink resources UL of a wireless access interface as illustrated generally by dashed arrow 64b to the source infrastructure equipment 74. The communications device 72 may similarly be configured to receive downlink data transmitted by the source infrastructure equipment 74 via downlink resources DL as indicated by dashed arrow 66b from the source infrastructure equipment 74 to the communications device 72. After the handover, the communications device 72 is shown to transmit uplink data to the target infrastructure equipment 76 via uplink resources UL of a wireless access interface as illustrated generally by solid arrow 66a to the target infrastructure equipment 76. The communications device 72 may similarly be configured to receive downlink data transmitted by the target infrastructure equipment 76 via downlink resources DL as indicated by solid arrow 64a from the target infrastructure equipment 76 to the communications device 72.

In FIG. 4, the source and target infrastructure equipment 74, 76 are each connected to a core network 60 via interfaces 61, 62 to a controller 74c, 76c of the respective infrastructure equipment 74 and 76. The source and target infrastructure equipment 74, 76 each include a receiver 74b, 76b connected to an antenna 74d, 76d and a transmitter 74a, 76a connected to the antenna 74d, 76d. Correspondingly, the communications device 72 includes a controller 72c connected to a receiver 72b which receives signals from an antenna 72d and a transmitter 72a also connected to the antenna 72d.

The controllers 74c, 76c are configured to control the source and target infrastructure equipment 74, 76 respectively and may comprise processor circuitry which may in turn comprise various sub-units/sub-circuits for providing functionality as explained further herein. These sub-units may be implemented as discrete hardware elements or as appropriately configured functions of the processor circuitry. Thus the controllers 74c, 76c may comprise circuitry which is suitably configured/programmed to provide the desired functionality using conventional programming/configuration techniques for equipment in wireless telecommunications systems. The transmitters 74a, 76a and the receivers 74b, 76b may comprise signal processing and radio frequency filters, amplifiers and circuitry in accordance with conventional arrangements. The transmitters 74a, 76a the receivers 74b, 76b and the controllers 74c, 76c are schematically shown in FIG. 4 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 74 will in general comprise various other elements associated with its operating functionality.

Correspondingly, the controller 72c of the communications device 72 is configured to control the transmitter 72a and the receiver 72b and may comprise processor circuitry which may in turn comprise various sub-units/sub-circuits for providing functionality as explained further herein. These sub-units may be implemented as discrete hardware elements or as appropriately configured functions of the processor circuitry. Thus the controller 72c may comprise circuitry which is suitably configured/programmed to provide the desired functionality using conventional programming/configuration techniques for equipment in wireless telecommunications systems. Likewise, the transmitter 72a and the receiver 72b may comprise signal processing and radio frequency filters, amplifiers and circuitry in accordance with conventional arrangements. The transmitters 72a, receivers 72b, and controllers 72c are schematically shown in FIG. 4 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 72 will in general comprise various other elements associated with its operating functionality, for example a power source, user interface, and so forth, but these are not shown in FIG. 4 in the interests of simplicity.

The controllers 74c, 72c may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

In wireless telecommunications networks, such as LTE and NR type networks, there are different Radio Resource Control (RRC) modes for terminal devices. For example, it is common to support an RRC idle mode (RRC_IDLE) and an RRC connected mode (RRC_CONNECTED). A terminal device in the idle mode may transition to connected mode, for example because it needs to transmit uplink data or respond to a paging request, by undertaking a random access procedure. The random access procedure involves the terminal device transmitting a preamble on a physical random access channel and so the procedure is commonly referred to as a RACH or PRACH procedure/process. As those skilled in the art would understand, typical RACH procedures may comprise either four steps (which are referred to as msg 1, msg2, msg3, and msg4) or two steps (which are referred to as msgA and msgB).

### 6G Wireless Communications and Sustainability in Telecommunications

As described above, several generations of mobile communications have been standardised globally up to now, where each generation took approximately a decade from introduction before the development and introduction of another new generation. For example, generations of mobile communications have moved from the Global System for Mobile Communications (GSM) (2G) to Wideband Code Division Multiple Access (WCDMA) (3G), from WCDMA (3G) to LTE (4G), and most recently from LTE (4G) to NR (5G).

The latest generation of mobile communications is 5G, as discussed above with reference to the example configurations of FIGS. 2 and 3, where a significant number of additional features have been incorporated in different releases to provide new services and capabilities. Such services include eMBB, IloT and URLLC as discussed above, but also include such services as 2-step Random Access (RACH), Unlicensed NR (NR-U), Cross-link Interference (CLI) handling for Time Division Duplexing (TDD), Positioning, Small Data Transmissions (SDT), Multicast and Broadcast Services (MBS), Reduced Capability UEs, Vehicular Communications (V2X), Integrated Access and Backhaul (IAB), UE power saving, Non Terrestrial Networks (NTN), NR operation up to 71 GHz, IoT over NTN, Non-public networks (NPN), and Radio Access Network (RAN) slicing.

Nevertheless, as in every decade, a new generation (e.g. 6G) is expected to be developed and deployed in the near future (around the year 2030), and will be expected to provide new services and capabilities that the current 5G cannot provide.

One of the areas for investigation for future mobile communications networks is uplink (UL) scheduling enhancements, which are expected to be required due to the increased number of services that require low latency communications and high reliability, as well as high throughput UL data transmissions from the terminal, like tactile internet, Audio-Video field production, and extended Reality (XR). In essence, it is proposed that a mobile terminal should be able to schedule unrestricted UL resources immediately after data arrives in its buffer for transmission, while taking into account the link adaptation parameters so that the transmissions are mostly ensured to be successful. Doing so would allow such mobile terminals to operate not only more efficiently, but also in a more sustainable manner, with less power being wasted. Sustainability is an increasingly important topic for 6G, and mobile network operators, network vendors, and mobile phone/other user equipment manufacturers are increasingly focussing on their carbon footprint. Seventeen goals for sustainable development have been identified by the United Nations [3], which are:
No poverty;
Zero hunger;
Good health and well-being;
Quality education;
Gender equality;
Clean water and sanitation;
Affordable and clean energy;
Decent work and economic growth;
Industry, innovation, and infrastructure;
Reduced inequalities;
Sustainable cities and communities;
Responsible consumption and production;
Climate action;
Life below water;
Life on land;
Peace, justice, and strong institutions; and
Partnerships for the goals.

There are a few use cases of mobile networks which are already known and are helping achieve some of these sustainability targets. For example, such sustainability targets being addressed by mobile networks may include no poverty (by raising awareness), zero hunger (through smart agriculture), good health (mobile health), quality education (remote and immersive learning), clean water and sanitation (smart cities), and industry innovation (services such as URLLC). However, the role of mobile networks in helping achieve some others of the above listed sustainability targets-such as affordable and clean energy, sustainable cities and communities, climate action, and life on Earth-are more questionable.

Mobile networks consume a considerable amount of energy in terms of their worldwide deployment. RAN networks particularly are the leaders in terms of energy consumption in current (i.e. mainly 4G) mobile network deployments. This is due to the deployment of all of the RAN equipment (such as base stations) in the field, as opposed to the more centralised deployment of core network apparatus. At the same time, mobile networks are handling higher and higher amounts of data generated by an ever increasing number of data hungry users, and hence the overall data usage is growing every month. With new radio access technologies like 5G and 6G, new services and use-cases requiring always-on data applications such as digital twin, XR, gaming, and the metaverse are proposed. Another development for 5G and beyond is that the spectrum used for the communication of data is a higher frequency spectrum (e.g. higher frequencies than used for previous generations of wireless communications networks), resulting in smaller cell sizes. All of these factors contribute to the necessary deployment of a greater amount of RAN equipment in order to meet ever increasing data and coverage/capacity requirements. These requirements go against the above-mentioned sustainability targets described in [3], and thus present a challenge for wireless network operators, network vendors, and mobile phone manufacturers in the overall effort to achieve these sustainability goals.

### Sustainable Handover

In the process of handing over a communications device, from, for example, a first cell to a second cell, information may be exchanged between the communications device and the wireless communications network so that the core network or the application server can adjust to the new environment of the communications device. In other words, a handover procedure relating to the handing over of a UE from a source cell to a target cell, which may be served respectively by a source infrastructure equipment and a target infrastructure equipment, may require transmission of information between the communications device and the core network. It should be noted that the handover of a communications device is from one serving infrastructure equipment to another infrastructure equipment, and one example of this is where the communications device moves from one cell to another, although this disclosure is not limited to the transition from one cell to another. For instance, in a RAN that operates without forming cells, the present disclosure may be implemented by a system wherein the serving infrastructure equipment changes for a communications device, without changing cells. In this breaking of connection and reformation of connection between the communications device and the wireless communications network, it is envisaged that there may be an opportunity to configure the system in line with the abovementioned sustainability goals. The present technique relates to this opportunity, and further details are given below.

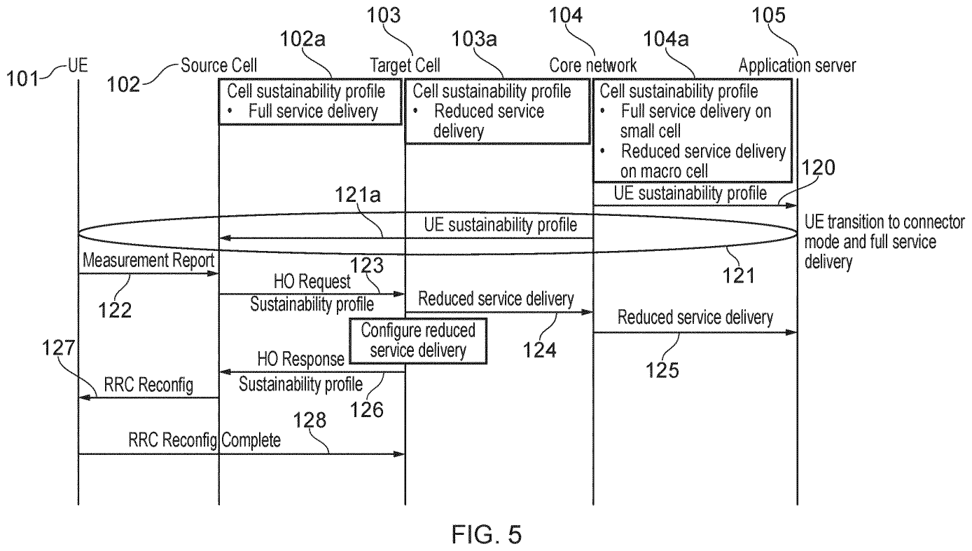

FIG. 5 shows a message flow diagram representation of a first wireless communications system comprising a communications device 101, a first infrastructure equipment, or a source cell, 102, a second infrastructure equipment, or target cell, 103, a core network 104, and an application server 105 in accordance with at least some embodiments of the present technique. The communications device 101 is configured to transmit signals to and/or receive signals from the wireless communications network (e.g. to/from the first infrastructure equipment serving source cell 102 and/or second infrastructure equipment serving target cell 103). Specifically, the communications device 101 may be configured to transmit data to and/or receive data from the wireless communications network (e.g. to/from the first infrastructure equipment serving source cell 102 and/or second infrastructure equipment serving target cell 103) via a wireless access interface provided by the wireless communications network (e.g. the Uu interface between the communications device 101 and the Radio Access Network (RAN), which includes the first infrastructure equipment serving source cell 102 and/or second infrastructure equipment serving target cell 103).

Following an agreement between a user of a communications device such as 101 and a service provider, for instance a network operator who may operate the core network 104 and infrastructure equipment serving cells, the service provider may create a sustainability profile for a user. In a particular example as demonstrated in the following Figure, the user is a sensitive user who may be in agreement with a reduction in service in order to increase a sustainability of the operation of the network. The profile, for instance user sustainability profile, may be created in the user subscription profile in an element of the core network such as a home subscriber service (HSS) or user device management (UDM). In other words, a user may agree with a service provider, e.g. network operator, in advance to receive either a full or a reduced service delivery from the network, depending on how sustainable a delivery of the service is. Alternatively, the profile may be created between a user and the application layer, e.g. application server.

In the example of FIG. 5, a cell is associated with a sustainability profile in addition to a user sustainability profile. For example, the source cell 102 in FIG. 1 has a sustainability profile indicating that it is configured to provide delivery of a full service to communications devices such as communications device 101. This could be per service provided to the communications device, i.e. per communications device in a cell, or the cell sustainability profile may be per cell. In other words, as shown in the example of FIG. 5, the source cell 102, and the target cell 103 have cell sustainability profiles associated with them. Specifically, cell sustainability profile 102a is associated with the source cell 102, and cell sustainability profile 103a is associated with the target cell 103. In particular, source cell sustainability profile 102a is an indication that the source cell supports full service delivery for a communications device in the source cell, and target cell sustainability profile 103a is an indication that the target cell supports a reduced service delivery for a communications device in the target cell. For example, the resolution of video (e.g. 4K->HD) and/or refresh rate (e.g. 120 frame per second to 30 frame per second) is reduced to save the radio resources. The sustainability profile is mainly related to sustainability target like power consumption. However, it may not be necessarily related to the sustainability target. For example, latency of backhaul link may depend on cell/base station. Latency mainly depends on the type of backhaul (optical fiber, mmWave, satellite and so on), which is connected to the cell/base station. If the latency is high, UE may select whether it accepts either the reduced service with high latency or gave up the service based on cell sustainability profile.

Core network 104 also contains an indication of a cell sustainability profile for at least one cell that the core network is connected to and this may be created and/or updated either by the RAN node or by the core network when the RAN node establishes the connection with the core network. In this example, cell sustainability profile 104a is an indication that the core network supports a full service delivery on a small cell, such as for example source cell 102, and an indication that the core network supports a reduced service delivery on a macro cell such as for example target cell 103.

In a first step 120, the core network 104 transmits to the application server 105 a UE sustainability profile. This may be achieved via any appropriate wired or wireless connection as the skilled person would implement a network side of the present disclosure. It is envisaged in a second step 121, that the communications device transitions from, for example, an idle mode to a connected mode, or resumes a service from an inactive mode that it has previously been in. As part of this step, the UE sustainability profile is transmitted from the core network 104 to the source cell 102 by a transmission 121a. Alternatively, it may be stored in the communications device context for an inactive state. As will be appreciated from the above discussion of the cell sustainability profile, the source cell supplies to a communications device a full service. At the conclusion of the second step 121, the communications device is in an active mode e.g. RRC_CONNECTED, and configured to transmit and receive signals in the source cell according to a full service. Based on the UE sustainability profile and a received set of Quality of Service/Quality of Experience, QoS/QoE, parameters for a Packet Data Unit, PDU, session received from the core network 104, the source cell 102 and accompanying infrastructure equipment may set up resources for this communications device 101. In this way, a user operating a communications device consumes a service in line with sustainability credentials and an agreed sustainability profile.

At a third step 122, the communications device 101 triggers a handover procedure by initiating a measurement report to be sent to the network. In other words, the communications device sends a measurement report to the source cell 102 infrastructure equipment, which forms part of the network. This may be performed by the communications device 101 when the communications device 101 moves outside of a coverage of the cell it is in, namely the source cell. In other example embodiments, the communications device 101 may trigger this measurement report transmission when the quality of signal received at the communications device 101 drops below a predetermined threshold. For example, a quality of signal in this situation may be synonymous with a reference signal received power, RSRP, or reference signal received quality, RSRQ. In other examples, the quality of signal might be associated with a signal to noise ratio, SNR, measured at the communications device for downlink communications, and measured at the infrastructure equipment for uplink communications. Alternatively, other measures of a signal quality may be employed by the skilled person, in line with their general technical knowledge. In addition, signals that the quality of signal is associated with may be control signals or signals representing data, or may be reference signals transmitted specifically for the purpose of making measurements, for example measurements of RSRP, RSRQ, or SNR. The source cell may determine a handover target cell 103 and send a handover request message to the cell in a following step 123. In this step, the source cell 102 may include in the transmission a sustainability profile associated with the communications device 101 and the user, and/or it may include service information in order to inform the target cell.

In response to this transition, and based on its own sustainability profile, the target cell 103 may decide to configure a reduced bandwidth for the same service. In this case, as will be appreciated, the application layer 105 must also reduce the rate of data to be transmitted to the communications device 101. There are a plurality of options for how an indication of this reduction in data rate should be communicated to the application layer 105.

One possible option is that the target cell 103 sends an indication of the reduction in data rate to be transmitted to the communications device 101 to the application layer, or application server, 105.

Another possible option is that the application layer 105 keeps track of different buffering levels in the communications device 101 and the network 104 in order to reduce the rate. In other words, the application layer may request at a particular periodicity updates of an amount of data held in data buffers at the communications device 101 and the network 104. It may then compare these two buffer data amounts, and if the amount of data held in a buffer at the network 104 exceeds the amount of data held in a buffer at the communications device 101 by a predetermined amount, or if the difference in data amounts held by the buffers changes by a predetermined amount in a set amount of time, the application layer 105 may reduce the rate of data to be sent to the communications device 101 in order to equalise the amount of data held in the two buffers. This may indicate that the communications device 101 is receiving a reduced bit rate from the network 104 via a relevant infrastructure equipment, either due to experiencing poor coverage from its infrastructure equipment, for example due to interference or some other impediment, or because of its sustainability profile and/or sustainability credentials. FIG. 5 shows a representation of the first possible option, where the target cell 103 indicates to the application layer 105 that the data rate transmitted to the communications device 101 will be reduced.

Likewise, there are a plurality of options as to when the application layer 105 is informed of a change in the data rate to be transmitted to the communications device 101. The target cell 103 may indicate this change to the core network 104 after determining the reduction in data rate for the communications device. This may be before or after sending to the infrastructure equipment serving the source cell 102, in other words to a serving node 102, a handover request acknowledgement message. The core network 104 would then send this indication to the application layer 105, which may then modify the QoS flow or PDU session with new parameters reflecting a reduced service delivery mode.

Alternatively, the Radio Access Network, that is the target cell 103, may notify the application layer 105 directly (e.g. not via the core network) via appropriate signalling. For example, the target cell 103 may use a user plane packet to inform the application layer 105 of the reduction in data rate to be transmitted to the communications device 101, in an analogous way to the use of an Explicit Congestion Notification, ECN, in an IP packet to inform the application layer of congestion, whereby new bits may be needed in IP header, greater detail of existing ECN procedure is provided in the annex. In other example embodiments, the application layer 105 may be informed via control plane signalling like a voice/video codec rate adaptation. See annex for further details and discussion of this rate adaptation. This voice/video codec rate adaptation may be performed if, for example, radio conditions for the communications device are not good i.e. below a certain threshold, or if the Radio Access Network is congested. An infrastructure equipment, such as that which serves the target cell 103, may send an uplink/downlink rate to the communications device 101 using a Media Access Control, MAC, Control Element, MAC-CE.

The communications device 101 may also request a rate adaptation with a MAC-CE to be transmitted to the wireless communications network. Following a transmission of the MAC-CE, the communications device 101 may start a prohibit timer, that is a timer within the period of which the communications device 101 is not permitted to send another MAC-CE to the wireless communications device to adapt the rate of data to be transmitted to the communications device 101. In other embodiments where data is transmitted from another communications device to the communications device 101, the communications device 101 may send a rate change request to the other communications device using a multimedia telephony, MMTEL, application. Further and better details are provided on MMTEL applications in the annex.

Continuing the description of FIG. 5, the target cell 103 transmits to the core network 104 an explicit indication of a determined reduction in data rate to be transmitted to the communications device 101. It performs this transmission of an explicit indication in a fifth step 124, and thereby informs the core network of a reduced service delivery to be provided to the communications device 101. Following this, the core network forwards this indication to the application layer, i.e. application server, 105 in a sixth step 125.

Having informed the application layer 105 of the reduced service delivery to be provided to the communications device 101, and thus having configured the reduced service delivery for the communications device 101 for the wireless communications network side, the target cell 103 transmits in step 126 to the source cell 102 a handover response, in response to the handover request transmitted from the source cell 102 to the target cell 103 in step 123. With this response message, the target cell 103 may include in the message a sustainability profile associated with the target cell 103, as this may indicate to the source cell 102 a reduction in the service to be provided to the communications device 101.

Following this, in step 127, the source cell 102 transmits to the communications device 101 a Radio Resource Control Reconfiguration, RRC Reconfig, message. This indicates to the communications device 101 a handover that has been arranged for it from the source cell 102 to the target cell 103. The method concludes in step 128 by the communications device 101 transmitting to the target cell 103 infrastructure equipment an indication that the handover has been completed, by transmitting a Radio Resource Control Reconfiguration Complete, RRC Reconfig Complete, signal. In this way, a handover from a source cell to a target cell may be performed by a communications device, and a sustainability profile related to the communications device and/or the target cell may be considered, and may influence the adaptation of the service delivered to the communications device.

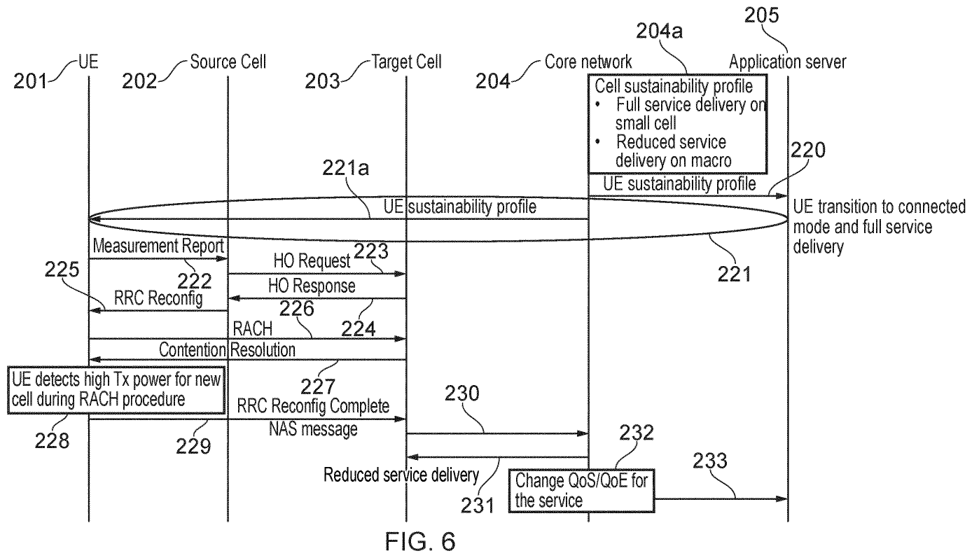

In another example embodiment, as shown in FIG. 6, a Radio Access Network cell is not involved in the handover in the same way, and the communications device and/or the User interacts with the core network for switching between sustainability profiles. In this case, the communications device determines a sustainability profile relating to the communications device based on a number of factors, including for example its transmission power (e.g. higher transmission power might be associated with a less sustainable sustainability profile) and the number of retransmissions with the cell (e.g. a greater number of retransmissions required for a message to be successfully received by the cell might be associated with a less sustainable sustainability profile). Having determined the sustainability profile related to the communications device, the communications device may inform the core network, for example via Non Access Stratum signalling, about the determined sustainability profile. During an initial connection process, this information may be included in a service request message, or may be signalled to the core network via some other appropriate method, such as dedicated signalling for that purpose.

For handover and establishing a connection with a target cell, a communications device may determine at approximately the same time as the communications device performs random access channel, RACH, procedure whether the communications device will change the sustainability profile. If an outcome of the determination is that the communications device changes the sustainability profile, then the communications device may include an indication related to this in an embedded NAS message to the core network in RRC Reconfiguration Complete message or a separate NAS message. If an outcome of the determination is that the communications device will not change the sustainability profile, then no further signalling may be required. For a communications device that is connecting to a cell of the wireless access network, having previously been in an inactive mode, that is when a connection between the communications device and the relevant serving infrastructure equipment is not actively transmitting and receiving signals, but the RRC is not completely released, an indication related to a change in sustainability profile may alternatively be included in an RRC Resume Complete message.

In particular, with reference to FIG. 6, an embodiment of the present techniques is depicted in a message flow diagram thereof. Analogously to FIG. 5, a communications device or user equipment UE, 201, a source cell 202, a target cell 203, a core network 204, and an application server, or application layer, 205 are depicted. The core network 204 has a communications device, UE, sustainability profile 204a associated with it, which specifies that a full service may be delivered to the communications device 201 on a small cell, for instance on a cell such as the source cell 202, and a reduced service may be delivered to the communications device 201 on a macro cell, that is a cell larger than some predetermined threshold, such as for example the target cell 203.

In a first step 220, the core network 204 transmits to the application server 205 an indication of the communications device sustainability profile 204a that it has stored. This allows the application layer 205 to be informed of the rate of data that may be sent to the communications device 201 depending on the cell that it is connected to, e.g. whether it is connected to the source cell 202 or the target cell 203.

In a second step 221, the communications device 201 transitions into a connected mode with the source cell 202. Since the communications device sustainability profile 204a indicates that full service delivery is available when on a small cell, such as the source cell 202, this transition to a connected mode also involves a full service being delivered to the communications device 201. This step involves the transmission 221a of the communications device sustainability profile 204a from the core network 204 to the communications device 201.

In a third step 222, the communications device 201 triggers a handover procedure by initiating a measurement report to be sent to the network. In other words, the communications device sends a measurement report to the source cell 202 infrastructure equipment, which forms part of the network. This is performed when a predetermined condition is met, such as, for example, the communications device 201 moving more than a set distance from an infrastructure equipment serving the communications device, moving outside of a coverage of a cell the communications device is in, namely the source cell 202, when a quality of signal (e.g. RSRP, RSRQ or SNR) is reduced below a predetermined threshold where this threshold could be set to a higher value for sustainability aware UE compared to a normal UE, or if a number of retransmissions of a signal to/from a serving infrastructure equipment such as that providing source cell 202 exceeds a predetermined number. This number could relate to HARQ retransmissions or RLC retransmissions for RLC-AM mode. This list of conditions is intended to be exemplary, and not limiting of the events which may cause a communications device such as UE 201 to transmit a measurement report. The skilled person would understand that other scenarios triggering the transmission of a measurement report are conceivable, and that this disclosure is intended to cover these scenarios also.

In a fourth step 223, the source cell 202 transmits a handover request to the target cell. Unlike in the example illustrated by FIG. 5, this example handover request may not be accompanied by a transmission of the communications device sustainability profile 204a.

In a fifth step 224, the target cell 203 responds to the source cell 202 by transmitting to it an indication of a handover response. This may be a confirmation of the handover procedure requested by the source cell in step 223. Then, the source cell 202 transmits to the communications device 201 an indication of a handover, for example in the form of a RRC Reconfig message. This provides information to the communications device 201 related to the target cell 203, which the communications device requires to send signals to and/or receive signals from an infrastructure equipment serving target cell 203.

With this information related to the target cell 203, the communications device 201 in step 226 performs a RACH procedure with respect to the target cell 203 and in step 227 receives a contention resolution message in response from the infrastructure equipment serving the target cell 203.

The communications device 201 may monitor the transmission power and other parameters such as the number of retransmissions required for connection with the target cell 203, and at step 228 detects that the transmission power required for transmission of signals as part of the RACH procedure is above a predetermined threshold. Responsive to this, the communications device 201 may then transmit 229 a NAS message to the infrastructure equipment serving the target cell 203, comprising an RRC Reconfig Complete message. A level of power for transmissions to the target cell, or a number of retransmissions required for successful communication, may be contrary to the communications device sustainability profile 204a, and thus the target cell, on receipt of the RRC Reconfig Complete message, forward the NAS message transparently to the core network and core network may determine that a service provided to the communications device 201 is to be amended.

This may be performed via a determination at the core network 204 and be transmitted to the application layer 205. However, in FIG. 6, an alternative is illustrated where, on receiving the RRC Reconfig Complete message as part of step 229, the target cell 203 sends 230 an indication of parameters related to the transmission of signals forming the connection between the communications device 201 and the target cell 203 to the core network 204. Having received information related to the connection between the target cell 203 and the communications device, and having stored an indication of the communications device sustainability profile 204a, the core network 204 may determine 232 that a quality of service, QoS, or a quality of experience, QoE, related to the service provided to the communications device are to be changed. If it determines that the QoS/QoE for the service are to be changed, the core network 204 may then inform 233 the application server 205 of the change to be made, so that the application layer can implement this change with respect to data sent to the communications device via the infrastructure equipment serving the target cell 203.

Those skilled in the art would appreciate that the methods shown by FIGS. 5 and 6 may be adapted in accordance with embodiments of the present technique. For example, other intermediate steps may be included in these methods, or the steps may be performed in any logical order. Though embodiments of the present technique have been described largely by way of the example communications system shown in FIGS. 5 and 6 it would be clear to those skilled in the art that they could be equally applied to other systems to those described herein.

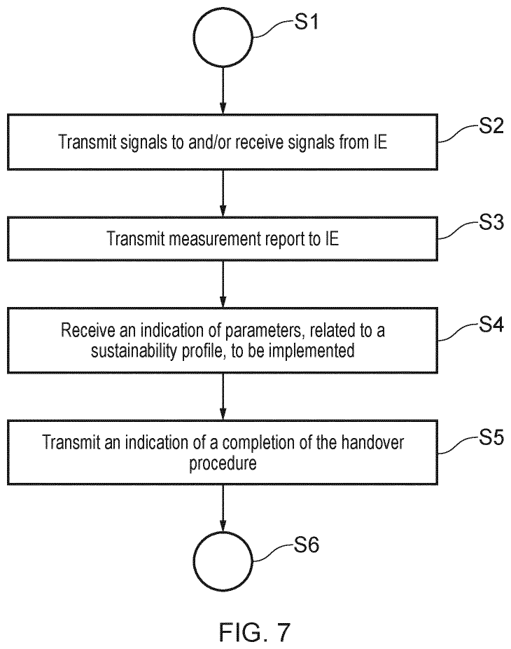

FIG. 7 depicts a flow diagram to be performed by a communications device, such as UE 101 of FIG. 5 or UE 201 of FIG. 6, in accordance with embodiments of the present technique. A process begins at a first step, S1, before proceeding to a second step, S2. In this step, the communications device transmits signals to and/or receives signals from an infrastructure equipment. This infrastructure equipment may be a serving infrastructure equipment, providing a wireless access interface to communications devices within a cell formed by the infrastructure equipment. It should be noted that the provision of the wireless access interface, and by extension, of the service delivery to the communications device, is performed in accordance with a certain sustainability profile.

Following this step, the process passes to a third step, S3. In this third step, the communications device transmits a measurement report to the infrastructure equipment. This measurement report may contain measurements such as the signal power used by the communications device for transmission, a received signal reference power, a signal to noise ratio, or other appropriate information that the communications device is configured to measure. This transmission of a measurement report, at the network side, triggers a handover procedure from a cell served by the infrastructure equipment to which the measurement report was sent to a cell served by a different infrastructure equipment. In some examples, these may be referred to as a first and second infrastructure equipment, and correspondingly a first and second cell served by the first and second infrastructure equipment respectively, or a source and target infrastructure equipment and cells. Alternatively, in an example not shown in FIG. 7, this step may be omitted if a trigger for the measurement report is based on a number of HARQ or RLC retransmissions, since the infrastructure equipment is already aware of this. In this case, the infrastructure equipment may still be informed by the communications device, or it may be detected at the source cell serving infrastructure equipment without any transmission from the communications device.

In response to the measurement report transmission of step 3, a fourth step S4 contains a step of receiving an indication of parameters to be implemented by the communications device. These parameters are related to a sustainability profile. The sustainability profile may be determined for individual users, that is for an individual communications device such as UE 101 or UE 201, or it may be related to the cells and infrastructure equipment serving the communications device. For example, certain infrastructure equipment and cells may be configured to operate with particular parameters such as a reduced maximum bitrate, a reduced average bitrate, reduced bandwidth, reduced error rate, or other Quality of Service/Quality of Experience parameters. Furthermore, the sustainability profile may be determined at the core network and transmitted to the communications device, or it may be determined by the communications device, and the core network may be informed of the parameters to be implemented in a connection between the communications device and the different/second/target cell. In yet another example, the sustainability profile is determined by the core network, and adaptation of the service delivery is performed by the core network in communication with the communications device. That is, the RAN is transparent to relevant signalling, such as NAS signalling, which only provides a link between the communications device and the core network and may alter or generate no new transmissions relating to this purpose. However the sustainability profile is created and managed, the communications device implements these parameters in establishing a connection with the different infrastructure equipment, and then the process passes to a fifth step, S5.

In this fifth step S5, the communications device transmits to the different infrastructure equipment, which now serves the communications device, an indication that the handover procedure triggered by the transmission of the measurement report in step S3 has been completed. Finally, the process passes to a step S6 and ends.

It would be apparent to one skilled in the art that other steps and processes may be performed by the communications device, and that the steps outlined above may be performed in an order other than the order in which they have been presented. Other steps and processes may be included in the process of the disclosed invention, without departing from the essential characteristics thereof, and the steps above may be performed in any order.

Further embodiments of the present invention relate to a creation and updating of a sustainability profile stored by the wireless communications network. The sustainability profile may be stored by an infrastructure equipment that is in communicative connection with a communications device to which the sustainability profile relates, or it may be stored by another entity forming part of the wireless communications network. For example, the sustainability profile may be stored in a core network, or in a dedicated server.

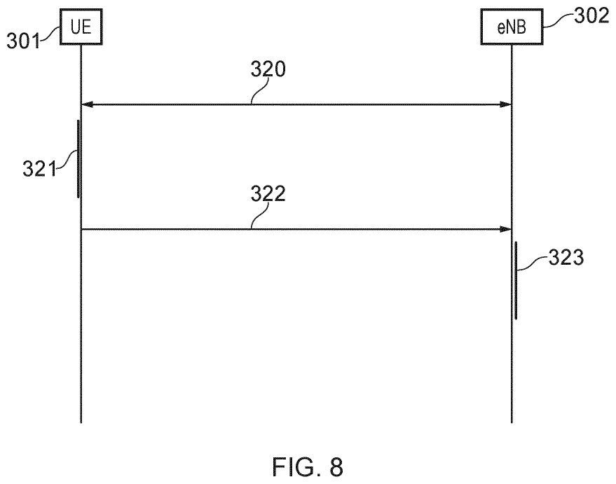

FIG. 8 depicts an example configuration of a message flow diagram for such a purpose, in accordance with certain embodiments of the present technique. FIG. 8 shows a communications device, represented as User Equipment, UE, 301, and an infrastructure equipment, represented by eNode B, eNB, 302. The communications device 301 may be substantially similar to communications device 101 of FIG. 5, and 201 of FIG. 6, whilst the infrastructure equipment might be substantially similar to either the source cell 102, 202 infrastructure equipment or the target cell 103, 203 infrastructure equipment. In a first step 320, signals are exchanged between the communications device and the infrastructure equipment. Following this, in a second step 321, the communications device 301 performs a determination process and determines that a sustainability profile related to the communications device 301 is required to be created or updated. This may be because a number of retransmissions for the transmissions between the communications device and the infrastructure equipment to be successfully received has exceeded a predetermined threshold, or it may be because a transmission power utilised by the communications device 301 has exceeded a separate predetermined threshold, or it may be because of another reason.

These above reasons are not intended to be limiting, and the skilled person will be able, with their technical knowledge, to conceive of other situations where the communications device determines that a sustainability profile related to it needs to be created or updated.

In response to this determination that a sustainability profile is to be created or updated, the communications device 301 transmits a signal 322 representing an indication of the determined sustainability profile. This is received by the infrastructure equipment, and subsequently a stored sustainability profile is created or updated, and stored in the network in a processing step 323. This stored sustainability profile may be the same as the indication of the determined sustainability profile, or it may be different to the indication of the determined sustainability profile. For example, the communications device may transmit to the infrastructure equipment details related to the sustainability profile, it may transmit only a subset of these details, or it may transmit only an indication such as representing “reduced service”. On receiving this, the network may store the received transmission, or it may store a representation of the transmission. In one instance, the network may receive an indication of “reduced service” from the communications device, but store a greater set of details related to the sustainability profile of the communications device to enable communications between the communications device and the infrastructure equipment to be more accurately controlled. In another example, the network may receive a full set of details related to a sustainability profile from the communications device, and it may store only an indication of “reduced service”, and not store the details themselves. After storage, the stored sustainability profile can then be employed by the network and the communications device when determining parameters related to communication between the communications device and the infrastructure equipment later.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

### ANNEX

### Explicit Congestion Notification

The infrastructure equipment and the communications device support of an Explicit Congestion Notification is specified in clause 5 of [4], the entirety of which is incorporated by reference.

### Support for MMTEL Voice and Video Enhancements

### Ran-Assisted Codec Adaptation

RAN-assisted codec adaptation provides a means for an infrastructure, such as an eNB, to send a codec adaptation indication, that may include a recommended bit rate, to assist the UE to select or adapt to a codec rate for MMTEL voice or MMTEL video. The RAN-assisted codec adaptation mechanism supports an uplink/downlink bit rate increase or decrease. For a bearer associated with configuration of MBR greater than GBR, the recommended uplink/downlink bit rate is within boundaries set by the MBR and GBR of the concerned bearer.

For uplink or downlink bit rate adaptation, an eNB may send a recommended bit rate to the UE to inform the UE of the currently recommended transport bit rate on the local uplink or downlink, which the UE may use in combination with other information to adapt the bit rate, e.g. the UE may send a bit rate request to a peer UE via application layer messages as specified in TS 26.114 [5], the entirety of which is incorporated herein by reference, which the peer UE may use in combination with other information to adapt the codec bit rate. The recommended bit rate may be in kbps at the physical layer at the time when the decision is made.

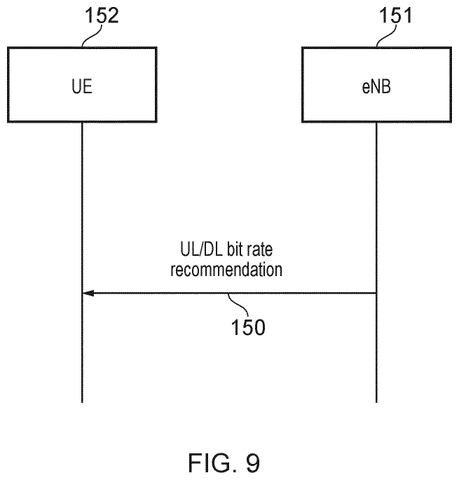

The recommended bit rate for UL and DL may be conveyed as a MAC Control Element (CE) from the infrastructure equipment to the communications device as outlined in FIG. 9. FIG. 9 essentially shows a transmission 150 of a signal representing a recommendation of an uplink, or alternatively of a downlink, bit rate. This signal is transmitted from an infrastructure equipment, represented by eNB 151 and received by a communications device, represented by UE 152.

Based on the recommended bit rate from the infrastructure equipment, a communications device such as the UE may initiate an end-to-end bit rate adaptation with its peer (UE or MGW). The UE may also send a query message to its local infrastructure equipment to check if a bit rate recommended by its peer can be provided by the infrastructure equipment. The UE is not expected to go beyond the recommended bit rate from the eNB.

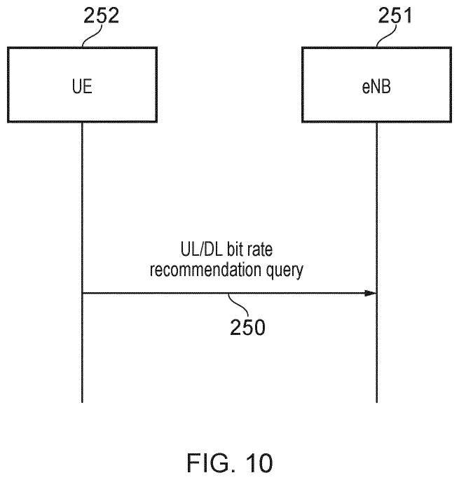

The recommended bit rate query message is conveyed as a MAC Control Element (CE) from the UE to the eNB as outlined in FIG. 10. Essentially, FIG. 10 shows a depiction of a signal 250 transmitted from a communications device represented by UE 252 and received at an infrastructure equipment represented by eNB 251. This signal represents data, and when received by the infrastructure equipment, provides a query as to the uplink, or alternatively as to the downlink, bit rate recommendation for transmission between the communications device and the infrastructure equipment.

A prohibit timer can be configured for each logical channel by the wireless communications network to limit communications devices such as the UE from sending frequent query MAC CEs. Independent prohibit timers are used for each direction (uplink and downlink) to prohibit the UE from retransmitting exactly the same query MAC CE to the infrastructure equipment during the configured time.

### MMTEL Signalling Optimisation

In case of network congestion (e.g. maximum number of users that can be connected, poor radio conditions, etc), an operator may want to prioritize MMTEL voice/MMTEL video access. For both type of accesses, the MO voice call cause value is used. During the re-direction procedure, if the UE receives the RRC Connection Release message with redirection and the voice call is ongoing, the UE keeps the call in the application layer. After the UE re-accesses the network, the voice GBR bearer can be recovered immediately.

### MMTEL Voice Quality/Coverage Enhancements

In order to enhance the voice quality and coverage, the techniques for PUSCH coverage enhancement introduced in Rel-13 for Control Element, CE, Mode A can be configured also for communications devices in non-CE mode. These techniques are applied in a new PUSCH enhancement mode and include:
PUSCH subframe repetition with intra-bundle or inter-bundle frequency hopping and
UL asynchronous HARQ operation.

The PUSCH enhancement mode can be enabled only on PCell. In the PUSCH enhancement mode, the PUSCH maximum bandwidth is 20 MHz. The transition of the communications device between a normal mode and a PUSCH enhancement mode is controlled and triggered by RRC signalling. As part of the transition procedure, the UL HARQ operation switches between synchronous (normal mode) and asynchronous (PUSCH enhancement mode), with a partial MAC reset.

PUSCH coverage enhancement may require that an air interface delay budget be relaxed to increase the robustness of the transmission. Such relaxation may be achieved when a UE in good coverage indicates a preference to the infrastructure equipment to reduce the local air interface delay by sending a UEAssistanceInformation message with delay BudgetReport set to type1 to decrease the DRX cycle length, so that the E2E delay and jitter can be reduced. A peer UE in bad coverage can send a UEAssistance Information message with delayBudgetReport set to type2 to its eNB to indicate a preference on Uu air interface delay adjustments, see TS 36.331 [6], TS 36.211[7], and TS 36.213 [8], the entirety of each document being incorporated herein by reference. Based on the UE report and other information, the E-UTRAN may configure the UE with coverage enhancement techniques. When the UE detects changes such as end-to-end MMTEL voice quality or local radio quality, the UE may inform the eNB its new preference by sending UEAssistanceInformation messages with updated contents.

The following numbered paragraphs provide further example aspects and features of the present technique:

### Paragraph 1

A method of operating a communications device configured to transmit signals to and/or receive signals from a wireless communications network via a wireless access interface provided by the wireless communications network, the wireless communications network comprising at least a first and a second infrastructure equipment, the method comprising
transmitting signals to and/or receiving signals from the first infrastructure equipment,
responsive to a condition being satisfied, triggering a handover procedure from the first infrastructure equipment to the second infrastructure equipment by transmitting a measurement report to the wireless communications network,
receiving, from the first infrastructure equipment, an indication of radio resource control parameters to be implemented by the communications device for communication with the second infrastructure equipment, wherein the radio resource control parameters to be implemented are related to a sustainability profile, and
transmitting, to the second infrastructure equipment, an indication of the completion of the handover procedure.

### Paragraph 2

The method of paragraph 1, wherein the condition is a reduction in signal quality with respect to the first infrastructure equipment below a predetermined threshold.

### Paragraph 3

The method of paragraph 2, wherein the reduction in signal quality is a reduction in at least one of reference signal received power, RSRP, reference signal received quality, RSRQ, or signal to noise ratio, SNR and the predetermined threshold is a predetermined threshold of at least one of RSRP, RSRQ, or SNR.

### Paragraph 4

The method of paragraph 2 or 3, wherein the reduction of signal quality is as a result of moving in a direction away from the first infrastructure equipment.

### Paragraph 5

The method of any preceding paragraph, wherein the sustainability profile is associated with the communications device.

### Paragraph 6

The method of any of paragraphs 1-4, wherein the sustainability profile is associated with the infrastructure equipment.

### Paragraph 7

The method of any preceding paragraph, wherein the sustainability profile is agreed between a user of the communications device and a service provider.

### Paragraph 8

The method of any of paragraphs 1-5, or 7, wherein the sustainability profile is stored in a user subscription profile in a core network element such as the home subscriber service, HSS, or user device management, UDM.

### Paragraph 9

The method of any of paragraphs 5, 7, or 8, wherein the communications device determines its sustainability profile based on at least one parameter related to the communications device transmission, the at least one parameter including transmission power and number of retransmissions.

### Paragraph 10

The method of paragraph 9, wherein the communications device, after determining its sustainability profile, informs the wireless communications network via Non-Access Stratum, NAS, signalling.

### Paragraph 11

The method of any preceding paragraph, wherein an implementation of the radio resource control parameters to be implemented by the communications device constitutes a reduced service delivery in comparison with a service delivered to the communications device by the first infrastructure equipment.

### Paragraph 12

The method of paragraph 11, wherein the reduced service comprises one or more of a reduced quality of service, QoS, or a reduced quality of experience, QoE.

### Paragraph 13

The method of paragraph 12, wherein the reduced quality of service includes at least one of a reduction in maximum, or average, bit rate, a reduction in bandwidth, or a reduction in error rate.

### Paragraph 14

The method of paragraph 13, wherein the communications device receives from an application layer forming part of the wireless communications network, via the first infrastructure equipment, an indication of a reduction in rate of data to be transmitted to the communications device using a Media Access Control, MAC, Control Element, MAC-CE.

### Paragraph 15

The method of paragraph 13, wherein the communications device transmits to an application layer forming part of the wireless communications network, via the first infrastructure equipment, an indication of a requested reduction in rate of data to be transmitted to the communications device using a Media Access Control, MAC, Control Element, MAC-CE.

### Paragraph 16

The method of paragraph 15, wherein after transmitting the indication of the requested reduction in rate of data to be transmitted, the communications device begins a prohibit timer, within the period of which the communications device is not permitted to transmit another indication of a requested reduction in rate of data to be transmitted.

### Paragraph 17

The method of paragraph 13, wherein the communications device transmits to a peer communications device an indication of a requested reduction in rate of data to be transmitted to the communications device using a multimedia telephony, MMTEL, application.

### Paragraph 18

A communications device comprising
a transceiver configured to transmit signals to and/or receive signals from a wireless communications network via a wireless access interface provided by the wireless communications network, the wireless communications network comprising at least a first and a second infrastructure equipment, and
a controller configured to control the transceiver
to transmit signals to and/or to receive signals from the first infrastructure equipment,
responsive to a condition being satisfied, to trigger a handover procedure from the first infrastructure equipment to the second infrastructure equipment by transmitting a measurement report to the wireless communications network,
to receive, from the first infrastructure equipment, an indication of radio resource control parameters to be implemented by the communications device for communication with the second infrastructure equipment, wherein the radio resource control parameters to be implemented are related to a sustainability profile, and
to transmit, to the second infrastructure equipment, an indication of the completion of the handover procedure.

### Paragraph 19

Circuitry for a communications device comprising
transceiver circuitry configured to transmit signals to and/or receive signals from a wireless communications network via a wireless access interface provided by the wireless communications network, the wireless communications network comprising at least a first and a second infrastructure equipment, and
controller circuitry configured to control the transceiver circuitry
to transmit signals to and/or to receive signals from the first infrastructure equipment,
responsive to a condition being satisfied, to trigger a handover procedure from the first infrastructure equipment to the second infrastructure equipment by transmitting a measurement report to the wireless communications network,
to receive, from the first infrastructure equipment, an indication of radio resource control parameters to be implemented by the communications device for communication with the second infrastructure equipment, wherein the radio resource control parameters to be implemented are related to a sustainability profile, and
to transmit, to the second infrastructure equipment, an indication of the completion of the handover procedure.

### Paragraph 20

A method of operating an infrastructure equipment forming part of a wireless communications network comprising at least a first and a second infrastructure equipment, the infrastructure equipment being configured to transmit signals to and/or receive signals from a communications device via a wireless access interface provided by the wireless communications network, the method comprising
transmitting signals to and/or receiving signals from the communications device,
receiving, from the communications device, a measurement report, the reception of the measurement report triggering a handover procedure from the first infrastructure equipment to the second infrastructure equipment, and
transmitting, to the communications device, an indication of radio resource control parameters to be implemented by the communications device for communication with the second infrastructure equipment, wherein the radio resource control parameters to be implemented are related to a sustainability profile.

### Paragraph 21

The method of paragraph 20, wherein, subsequent to a completion of the handover procedure of the communications device from the first infrastructure equipment to the second infrastructure equipment, an application layer reduces a rate of data to be sent to the communications device via the second infrastructure equipment in accordance with a reduction in maximum bit rate, a reduction in bandwidth, or a reduction in error rate.

### Paragraph 22

An infrastructure equipment forming part of a wireless communications network comprising at least a first and a second infrastructure equipment, the infrastructure equipment comprising
a transceiver configured to transmit signals to and/or receive signals from a communications device via a wireless access interface provided by the wireless communications network, and
a controller configured to control the transceiver
to transmit signals to and/or to receive signals from the communications device,
to receive, from the communications device, a measurement report, the reception of the measurement report triggering a handover procedure from the first infrastructure equipment to the second infrastructure equipment, and
to transmit, to the communications device, an indication of radio resource control parameters to be implemented by the communications device for communication with the second infrastructure equipment, wherein the radio resource control parameters to be implemented are related to a sustainability profile.

### Paragraph 23

Circuitry for an infrastructure equipment forming part of a wireless communications network comprising circuitry for at least a first and a second infrastructure equipment, the circuitry for an infrastructure equipment comprising
transceiver circuitry configured to transmit signals to and/or receive signals from a communications device via a wireless access interface provided by the wireless communications network, and
controller circuitry configured to control the transceiver circuitry
to transmit signals to and/or to receive signals from the communications device,
to receive, from the communications device, a measurement report, the reception of the measurement report triggering a handover procedure from the first infrastructure equipment to the second infrastructure equipment, and
to transmit, to the communications device, an indication of radio resource control parameters to be implemented by the communications device for communication with the second infrastructure equipment, wherein the radio resource control parameters to be implemented are related to a sustainability profile.

### Paragraph 24

A wireless communications system comprising a communications device according to paragraph 18 and an infrastructure equipment according to paragraph 22.

### Paragraph 25

A computer program comprising instructions which, when loaded onto a computer, cause the computer to perform a method according to paragraph 1 or paragraph 20.

A non-transitory computer-readable storage medium storing a computer program according to paragraph 25.

### Paragraph 27

A method of operating a communications device configured to transmit signals to and/or receive signals from a wireless communications network via a wireless access interface provided by the wireless communications network, the method comprising
transmitting signals to and/or receiving signals from the wireless communications network,
determining that a sustainability profile related to the communications device is to be created, wherein the sustainability profile is determined by the communications device based on at least one parameter including transmission power and number of retransmissions employed by the communications device, or
determining that a sustainability profile related to the communications device is to be updated, wherein the sustainability profile is determined by the communications device based on at least one parameter including transmission power and number of retransmissions employed by the communications device, and
transmitting to the wireless communications network an indication of the determined sustainability profile.

### Paragraph 28

A communications device comprising
a transceiver configured to transmit signals to and/or receive signals from a wireless communications network via a wireless access interface provided by the wireless communications network, the wireless communications network comprising at least a first infrastructure equipment, and
a controller configured to control the transceiver
to transmit signals to and/or receive signals from the wireless communications network,
to determine that a sustainability profile related to the communications device is to be created wherein the sustainability profile is determined by the communications device based on at least one parameter including transmission power and number of retransmissions employed by the communications device, or
to determine that a sustainability profile related to the communications device is to be updated, wherein the sustainability profile is determined by the communications device based on at least one parameter including transmission power and number of retransmissions employed by the communications device, and
to transmit to the wireless communications network an indication of the determined sustainability profile.

### Paragraph 29

Circuitry for a communications device comprising
transceiver circuitry configured to transmit signals to and/or receive signals from a wireless communications network via a wireless access interface provided by the wireless communications network, the wireless communications network comprising circuitry for at least a first infrastructure equipment, and
controller circuitry configured to control the transceiver circuitry
to transmit signals to and/or receive signals from the wireless communications network,
to determine that a sustainability profile related to the circuitry for the communications device is to be created wherein the sustainability profile is determined by the circuitry for the communications device based on at least one parameter including transmission power and number of retransmissions employed by the circuitry for the communications device, or
to determine that a sustainability profile related to the circuitry for the communications device is to be updated, wherein the sustainability profile is determined by the circuitry for the communications device based on at least one parameter including transmission power and number of retransmissions employed by the circuitry for the communications device, and
to transmit to the wireless communications network an indication of the determined sustainability profile.

### Paragraph 30

A method of operating an infrastructure equipment forming part of a wireless communications network comprising at least a first infrastructure equipment, the infrastructure equipment being configured to transmit signals to and/or receive signals from a communications device via a wireless access interface provided by the wireless communications network, the method comprising
transmitting signals to and/or receiving signals from the communications device,
receiving an indication of a determined sustainability profile, and
creating and/or updating a stored sustainability profile related to the communications device based on the determined sustainability profile.

### Paragraph 31

An infrastructure equipment forming part of a wireless communications network comprising at least a first infrastructure equipment, the infrastructure equipment comprising
a transceiver configured to transmit signals to and/or receive signals from a communications device via a wireless access interface provided by the wireless communications network, and
a controller configured to control the transceiver
to transmit signals to and/or to receive signals from the communications device,
to receive an indication of a determined sustainability profile, and
to create and/or to update a stored sustainability profile related to the communications device based on the determined sustainability profile.

### Paragraph 32

Circuitry for an infrastructure equipment forming part of a wireless communications network comprising at least circuitry for a first infrastructure equipment, the circuitry for the infrastructure equipment comprising
transceiver circuitry configured to transmit signals to and/or receive signals from a communications device via a wireless access interface provided by the wireless communications network, and
controller circuitry configured to control the transceiver circuitry
to transmit signals to and/or to receive signals from the communications device,
to receive an indication of a determined sustainability profile, and
to create and/or to update a stored sustainability profile related to the communications device based on the determined sustainability profile.

### Paragraph 33

A wireless communications system comprising a communications device according to paragraph 28 and an infrastructure equipment according to paragraph 31.

### Paragraph 34

A computer program comprising instructions which, when loaded onto a computer, cause the computer to perform a method according to paragraph 27 or paragraph 30.

### Paragraph 35

A non-transitory computer-readable storage medium storing a computer program according to paragraph 34.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### References

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, 3rd Generation Partnership Project, v14.3.0, August 2017.
[3] United Nations, “Sustainable Development Goals”, [Online], Available at: https://sdgs.un.org/goals.
[4] IETF RFC 3168 (09/2001): “The Addition of Explicit Congestion Notification (ECN) to IP”.
[5] TS 26.114 “IP Multimedia Subsystem (IMS); Multimedia Telephony; Media handling and interaction (Release 7)”, 3^{rd} Generation Partnership Project, v7.4.0, March 2008.
[6] TS 36.331 “Radio Resource Control (RRC); Protocol specification (Release 10)”, 3^{rd} Generation Partnership Project, v10.13.0, June 2014.
[7] TS 36.211 “Physical Channels and Modulation (Release 10)”, 3^{rd} Generation partnership Project, v10.4.0, December 2011
[8] TS 36.213 “Physical layer procedures (Release 12)”, 3^{rd} Generation Partnership Project, v12.8.0, December 2015.

1. A method of operating a communications device configured to transmit signals to and/or receive signals from a wireless communications network via a wireless access interface provided by the wireless communications network, the wireless communications network comprising at least a first and a second infrastructure equipment, the method comprising
transmitting signals to and/or receiving signals from the first infrastructure equipment,
responsive to a condition being satisfied, triggering a handover procedure from the first infrastructure equipment to the second infrastructure equipment by transmitting a measurement report to the wireless communications network,
receiving, from the first infrastructure equipment, an indication of radio resource control parameters to be implemented by the communications device for communication with the second infrastructure equipment, wherein the radio resource control parameters to be implemented are related to a sustainability profile, and
transmitting, to the second infrastructure equipment, an indication of the completion of the handover procedure.

2. The method of claim 1, wherein the condition is a reduction in signal quality with respect to the first infrastructure equipment below a predetermined threshold.

3. The method of claim 2, wherein the reduction in signal quality is a reduction in at least one of reference signal received power, RSRP, reference signal received quality, RSRQ, or signal to noise ratio, SNR and the predetermined threshold is a predetermined threshold of at least one of RSRP, RSRQ, or SNR.

4. The method of claim 2, wherein the reduction of signal quality is as a result of moving in a direction away from the first infrastructure equipment.

5. The method of claim 1, wherein the sustainability profile is associated with the communications device.

6. The method of claim 1, wherein the sustainability profile is associated with the infrastructure equipment.

7. The method of claim 1, wherein the sustainability profile is agreed between a user of the communications device and a service provider.

8. The method of claim 5, wherein the sustainability profile is stored in a user subscription profile in a core network element such as the home subscriber service, HSS, or user device management, UDM.

9. The method of claim 5, wherein the communications device determines its sustainability profile based on at least one parameter related to the communications device transmission, the at least one parameter including transmission power and number of retransmissions.

10. The method of claim 9, wherein the communications device, after determining its sustainability profile, informs the wireless communications network via Non-Access Stratum, NAS, signalling.

11. The method of claim 1, wherein an implementation of the radio resource control parameters to be implemented by the communications device constitutes a reduced service delivery in comparison with a service delivered to the communications device by the first infrastructure equipment.

12. The method of claim 11, wherein the reduced service comprises one or more of a reduced quality of service, QoS, or a reduced quality of experience, QoE.

13. The method of claim 12, wherein the reduced quality of service includes at least one of a reduction in maximum, or average, bit rate, a reduction in bandwidth, or a reduction in error rate.

14. The method of claim 13, wherein the communications device receives from an application layer forming part of the wireless communications network, via the first infrastructure equipment, an indication of a reduction in rate of data to be transmitted to the communications device using a Media Access Control, MAC, Control Element, MAC-CE.

15. The method of claim 13, wherein the communications device transmits to an application layer forming part of the wireless communications network, via the first infrastructure equipment, an indication of a requested reduction in rate of data to be transmitted to the communications device using a Media Access Control, MAC, Control Element, MAC-CE.

16. The method of claim 15, wherein after transmitting the indication of the requested reduction in rate of data to be transmitted, the communications device begins a prohibit timer, within the period of which the communications device is not permitted to transmit another indication of a requested reduction in rate of data to be transmitted.

17. The method of claim 13, wherein the communications device transmits to a peer communications device an indication of a requested reduction in rate of data to be transmitted to the communications device using a multimedia telephony, MMTEL, application.

18. A communications device comprising
a transceiver configured to transmit signals to and/or receive signals from a wireless communications network via a wireless access interface provided by the wireless communications network, the wireless communications network comprising at least a first and a second infrastructure equipment, and
a controller configured to control the transceiver
to transmit signals to and/or to receive signals from the first infrastructure equipment,
responsive to a condition being satisfied, to trigger a handover procedure from the first infrastructure equipment to the second infrastructure equipment by transmitting a measurement report to the wireless communications network,
to receive, from the first infrastructure equipment, an indication of radio resource control parameters to be implemented by the communications device for communication with the second infrastructure equipment, wherein the radio resource control parameters to be implemented are related to a sustainability profile, and
to transmit, to the second infrastructure equipment, an indication of the completion of the handover procedure.

19.-21. (canceled)

22. An infrastructure equipment forming part of a wireless communications network comprising at least a first and a second infrastructure equipment, the infrastructure equipment comprising
a transceiver configured to transmit signals to and/or receive signals from a communications device via a wireless access interface provided by the wireless communications network, and
a controller configured to control the transceiver
to transmit signals to and/or to receive signals from the communications device,
to receive, from the communications device, a measurement report, the reception of the measurement report triggering a handover procedure from the first infrastructure equipment to the second infrastructure equipment, and
to transmit, to the communications device, an indication of radio resource control parameters to be implemented by the communications device for communication with the second infrastructure equipment, wherein the radio resource control parameters to be implemented are related to a sustainability profile.

23.-35. (canceled)
